(19) United States
(12) Patent Application Publication
(10) Pub. No.: US 2006/0096323 A1
(43) Pub. Date: May 11, 2006

(54) Mold for molding glass pieces and method for manufacturing such mold

(75) Inventor: Charles Leu, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/187,245

(22) Filed: Jul. 22, 2005

(30) Foreign Application Priority Data
Nov. 5, 2004 (CN) 200410052165.X

(51) Int. Cl. C03B 11/08

(52) U.S. Cl. 65/374.11

(57) ABSTRACT

A mold (1) includes a substrate (10), a metal core (20), and a protecting film (30). The substrate is made of NEOCERAM®, a kind of material resistance to heat shock and difficult to crack. The substrate defining a cavity (101) therein and the metal core integrally fixed in the cavity. The substrate has a projecting part (102), and the top of the projecting part defines a molding cavity (103) whose surface is covered with the protecting film. A method for manufacturing such mold includes the following steps: forming a NEOCERAM cuboid; machining a projecting part at one end of the NEOCERAM cuboid; machining a molding cavity in the projecting part; defining a cavity in the cuboid and integrally fixing a metal core in the cavity; and covering the surface of the molding cavity with a protecting film made of boron nitride (BN).

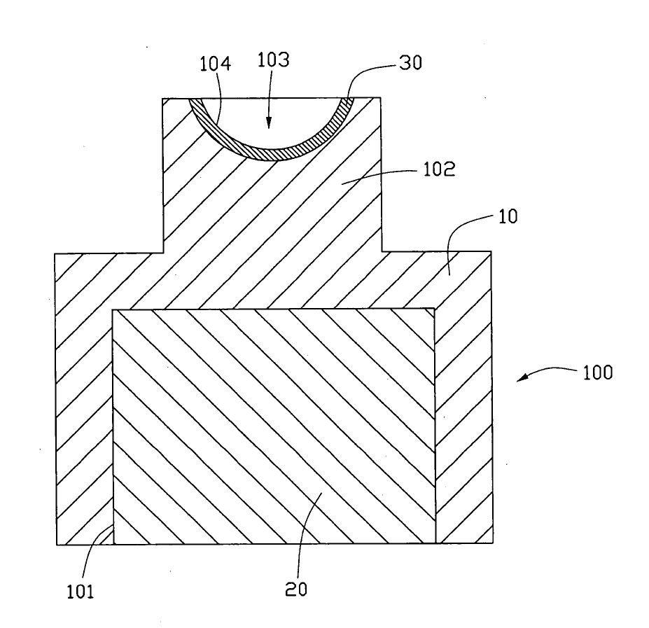

### FIELD OF THE INVENTION

The present invention relates to a mold for molding glass pieces such as lenses, and also relates to a method for manufacturing such mold.

### BACKGROUND

Regarding a mold used for molding glass pieces such as lenses, it is important that (1) a material of the molding surface of the mold does not react with or adhere to the glass material, (2) the molding surface is hard enough not to be damaged by scratching or the like, (3) the mold is strong and does not deform, even at very high temperatures, (4) the mold is highly resistant to heat shock, (5) the machinability of the mold is excellent so as to reduce the machining time and cost, and (6) the service lifetime of the mold is long so as to reduce costs.

A mold for molding glass pieces generally includes a substrate and a protecting film. A buffer layer is generally provided between the substrate and the protecting film. The substrate can be made of one of stainless steel, silicon carbide (SiC), and tungsten carbide (WC). The buffer layer is for ensuring that the protecting film firmly adheres to the substrate, and for improving a machinability of the mold. The protecting film is for ensuring high molding precision of the glass, and for preventing the glass material from adhering to the mold. The protecting film can be made of amorphous carbon, a hard ceramic material such as silicon carbide or silicon nitride (Si₃N₄), and a noble metal alloy mainly including platinum (Pt), iridium (Ir) or ruthenium (Ru), and so on.

Conventional protecting films generally have some shortcomings. For example, an amorphous carbon protecting film is apt to crack, be scratched, be oxidized, or be damaged by shock. A thermal conductivity of the amorphous carbon protecting film is also considered to be unsatisfactory. In addition, a mold having a hard ceramic protecting film is difficult to machine. Furthermore, the hard ceramic material generally contains additives such as aluminum oxide (AlO_{X}) and boric oxide (B₂O₃), which are apt to react with the glass material. This makes it difficult to remove the molding glass piece from the mold. A mold with a noble metal protecting film generally cannot withstand high temperatures. For example, the temperature threshold of a Pt—Ir alloy is about 520° C.˜550° C. High molding temperatures are generally apt to result in thermal etching, whereby the surface of the mold may crack rapidly. Additionally, the mold is unduly expensive.

What is needed, therefore, is a mold which is inexpensive, has a long service lifetime, and which molds glass pieces with high precision. What is also needed is a method for making such mold.

### SUMMARY

In preferred embodiments herein, a mold for molding glass pieces includes a substrate, a metal core and a protecting film. The substrate is made of NEOCERAM®, a kind of material resistant to thermal shock and resistant to cracking. The substrate defining a cavity therein and the metal core integrally fixed in the cavity. The substrate has a projecting part outside, and the top of the projecting part defines a molding cavity whose surface is covered with the protecting film.

The preferred embodiments also provide a method for manufacturing the above-described mold. The method includes the following steps: forming a NEOCERAM cuboid; machining a projecting part at one end of the NEOCERAM cuboid; machining a molding cavity in the projecting part; defining a cavity in the cuboid and integrally fixing a metal core in the cavity; and covering the surface of the molding cavity with a protecting film made of boron nitride (BN).

The substrate is made of NEOCERAM, a kind of material resistant to heat shock and not easily cracked. Accordingly, the mold for molding glass pieces can tolerate high temperatures, and not easy to scratch or crack. Therefore, the mold has a long service lifetime, and can be used to make glass pieces having fine precision. In addition, the cost of NEOCERAM is lower than that of the conventionally used tungsten carbide (WC). A machinability of the NEOCERAM is also excellent. Furthermore, the amount of NEOCERAM required to obtain the substrate is minimized. This is because the substrate has a cavity, which is filled with the relatively inexpensive metal core. Thus the cost of the mold can be further reduced.

Other advantages and novel features will become more apparent from the following detailed description of preferred embodiments when taken in conjunction with the accompanying drawing, in which:

### BRIEF DESCRIPTION OF THE DRAWING

The drawing is a cross-sectional view of a mold for molding glass pieces in accordance with a preferred embodiment of the present invention.

### DETAILED DESCRIPTION OF PREFERRED EMBODIMENT

Referring to the drawing, in a preferred embodiment of the present invention, a mold 100 for molding glass pieces includes a substrate 10, a metal core 20, and a protecting film 30 formed on the substrate 10.

The substrate 10 is made of a ceramic material. The ceramic material is preferably NEOCERAM®, which is sold by Stemmerich, Inc. of St. Louis, Mo. NEOCERAM is a kind of transparent ceramic material that is resistant to heat shock and resistant to cracking. NEOCERAM is generally formed by deposition of a beta-quartz material that is capable of tolerating a temperature of 100° C. A thermal dilatability coefficient of NEOCERAM is nearly zero. Further, a machinability of NEOCERAM is excellent, and a preform of NEOCERAM can be easily worked into any desired shape. The substrate further includes a cavity 101. The metal core 20 is integrally fixed in the cavity 101. The substrate has a projecting part 102, opposite from the cavity 101. The projecting part 102 defines a molding cavity 103 therein. The molding cavity 103 is bounded by a molding surface 104.

The metal core 20 is generally made of steel or cast iron. A size of the metal core 20 is substantially equal to that of the cavity 101, so that the metal core 20 can be integrally fixed in the cavity 101.

The protecting film 30 is a layer of boron nitride (BN) deposited on the molding surface 104 by a sputtering deposition process or a chemical vapor deposition process. The boron nitride can tolerate high temperatures of 2500° C. The protecting film 30 made of boron nitride is for protecting the molding surface 104 from scratching. Thus, the service lifetime of the mold 100 can be prolonged.

A method for manufacturing the mold 100 includes the following steps: (a) forming a NEOCERAM® block with beta-quartz; (b) forming a projecting part 102 at one end of the block; (c) defining a molding cavity 103 in the projecting part 102; (d) defining a cavity 101 in the block, and integrally fixing a metal core in the cavity 101; and (e) forming a protecting film 30 of BN on a surface bounding the molding cavity 103 by sputtering or by chemical vapor deposition.

In summary, the substrate 10 is made of NEOCERAM, which is resistant to heat shock and resistant to cracking. The mold 100 for molding glass pieces can tolerate high temperatures, and is not easily scratched or cracked. Therefore, the mold 100 has a long service lifetime, and can be used to make glass pieces having fine precision. In addition, the cost of NEOCERAM is lower than that of the conventionally used tungsten carbide (WC). A machinability of the NEOCERAM is also excellent. Furthermore, the amount of NEOCERAM required to obtain the substrate 10 is minimized. This is because the substrate 10 has the cavity 101, which is filled with the relatively inexpensive metal core 20. Thus the cost of the mold 100 can be further reduced.

It is believed that the embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

I claim:

1. A mold for molding glass pieces, comprising:
a substrate formed of NEOCERAM®, the substrate defining a cavity therein;
a metal core integrally fixed in the cavity; and
a protecting film formed on a molding surface of the substrate.

2. The mold as claimed in claim 1, wherein the substrate has a projecting part defining a molding cavity.

3. The mold as claimed in claim 2, wherein the molding cavity is bounded by the molding surface having the protecting film formed thereon.

4. The mold as claimed in claim 3, wherein the protecting film comprises boron nitride (BN).

5. The mold as claimed in claim 3, wherein the protecting film is formed on the substrate by sputtering deposition.

6. The mold as claimed in claim 3, wherein the protecting film is formed on the substrate by chemical vapor deposition.

7. A method for manufacturing a mold for use in molding glass pieces, comprising the steps of:
(1) forming a NEOCERAM® block;
(2) forming a projecting part at one end of the NEOCERAM block;
(3) defining a molding cavity in the projecting part;
(4) defining a cavity in the block, and integrally fixing a metal core in the cavity; and
(5) forming a protecting film on a surface of the projecting part bounding the molding cavity.

8. The method as claimed in claim 7, wherein the protecting film comprises boron nitride (BN).

9. A method to manufacture a mold, comprising the steps of:
preparing a substrate, having a molding surface thereon for molding, made of ceramic material acquired by means of a depositing process; and
adhering a protecting film onto said molding surface to form a final mold.

10. The method as claimed in claim 9, wherein said deposited ceramic material is NEOCERAM®.

11. The method as claimed in claim 9, wherein said protecting film comprises boron nitride (BN).

12. The method as claimed in claim 9, further comprising the step of forming a cavity in said substrate to integrally contain a metal core therein.
